(19) United States
(12) Patent Application Publication
(10) Pub. No.: US 2017/0178209 A1
(43) Pub. Date: Jun. 22, 2017

(54) METHOD AND SYSTEM FOR LOCAL INTERNET AND CLOUD COMMERCE

(71) Applicant: ELIAS ANDRES CIUDAD, PARLIN, NJ (US)

(72) Inventor: ELIAS ANDRES CIUDAD, PARLIN, NJ (US)

(21) Appl. No.: 15/383,901

(22) Filed: Dec. 19, 2016

Related U.S. Application Data
(60) Provisional application No. 62/269,934, filed on Dec. 19, 2015.

(51) Int. Cl. G06Q 30/06; G06Q 10/08; G06Q 30/02; H04L 29/08

(52) U.S. Cl. CPC G06Q 30/0601; H04L 67/10; H04L 67/02; H04L 67/18; G06Q 10/083; G06Q 30/0277

(57) ABSTRACT

The present invention relates to the field of Internet and cloud commerce, more specifically in the methods and systems local commerce through use of the Internet, also known as the cloud, with the use of geo locations. In other aspect, the present invention relates to members within an organization able to utilize their geo locations to procure goods and services from a network/marketplace of vetted merchants and service providers with the opportunity of the offers to be given to local merchants or service providers closer to the member of the organization recipient geo location as possible. The present invention is also directed to a method and system for enhancing local merchants, service providers and members' economies. Merchants, and service providers participating in the network/marketplace be able to introduce marketing opportunities in their geo location positioned environments.

### REFERENCE TO RELATED APPLICATIONS

I claim priority to provisional patent application with EFS ID: 24418950, Application No. 62/269,934, Confirmation Number: 2157, filed on Dec. 19, 2015.

### FEDERALLY SPONSORED RESEARCH OR DEVELOPMENT

Not Applicable

### THE NAMES OF THE PARTIES TO A JOINT RESEARCH AGREEMENT

Not Applicable

### MATERIAL SUBMITTED ON A COMPACT DISC

Not Applicable

### BACKGROUND

1. Field of the Invention

The present invention relates generally to the field of internet and cloud electronic commerce transactions. More particularly, the present invention relates to methods and systems for local internet/cloud commerce using geo locations for the delivery of goods and services. The invention also relates to the usage of organizations composed of member nodes to procure goods and services from vetted participating merchants in a selected internet marketplace.

2. Related Art

The Internet, also referred as the cloud has done an excellent job of bringing people and business together. There are many goods and services that can be purchased from the Internet. Buyers, clients or consumers often find themselves expending a great deal of time on researching for goods and services of all types and magnitudes, just to find that their procurement are not displayed and offered first, for the locale in which their recipients reside, operate, or are in-transit. Buyers, clients or consumers also find themselves login into accounts at multiple websites to search for goods and services and in some instances, they need to login into marketplaces in order to search for what they are looking for, then, they find that the procurements to be delivered, are being offered in another locale, region or country. It is very difficult to search for the information in the Internet/cloud on services without getting hundreds or thousands of results and not having the ability to validate if they are legitimate business and they provide real goods and services. Buyers, clients or consumers often realize that if they find the goods and services they need, those cannot be delivered at the location where the recipient is located within acceptable time and delivery cost because they are in another locale, region or country. More often, buyers, clients and consumers find that offers for services and goods cannot be trusted because they cannot the trust and validate the legibility of the offeror and the offer.

### BRIEF SUMMARY OF THE INVENTION

These and other problems are solved by the present invention which comprises of systems and methods for acquiring services products from a network of participating service providers and merchants by using the longitude and latitude and geo locations of the recipient(s) where the services and products will be delivered or rendered as shown in some embodiments.

In some embodiments, with this invention of methods and system for local internet and cloud commerce, members of organizations not limited to families, religious groups, professional associations, educational associations, sporting groups, cultural and civic associations, business, travelers associations and others, will be able to use their members profiles and current locations defined by longitude and latitude in combination with geo location position to obtain services and products available at the vetted network/marketplace in the internet, as shown on other embodiments.

Methods and system for local internet and cloud commerce are presented in other embodiments. In some embodiments, a method includes the display of login member node in a display device of a computer system or other devices connected to the internet, also known as the cloud. In other embodiment, a method further include the ability to login into the network/marketplace from the organization in which the member's node is associated. The method further includes the display of more than one node associated with specific organization and the member login node. A method further display the geo locations of the login member node and additional nodes associated with the organization and the login node. The method further includes from an input device of a computer system or other device connected to the internet, the receipt of the selected related additional nodes. Then, in response to the receipt of the nodes, the method connect to a network or marketplace of service providers, retailers, professionals and wholesalers and allows then login member node to select a specific related node or nodes from the organization. The method further display the selection of the related node and allowing to select services and goods from the network/marketplace for participating vendors and service providers, based on the geo location of the recipient node.

In still other embodiments, this invention uses the members profile and the location noted to search and improve the results for the availability of goods and services from participating merchants and service providers in the area, where the recipient member is located, minimizing in this way the search time and reducing the time on the search for goods and services for that specific need, purpose, occasion, desire, or opportunity, as shown in the embodiments of this method and system for local internet and cloud commerce. The method further inspects, process the geo location of the selected related member nodes, and calculates based on that information and geo location, the closest location in the search to obtain the goods and services from a vetted participant vendor or merchant.

Further in other embodiment, this invention provides a method to access a network/marketplace of service providers and merchants that are vetted and validated as being a legitimate business people and merchants by entities in the locale, region or government.

### BRIEF DESCRIPTION OF THE DRAWINGS

A further understanding of the nature and capabilities of the present invention may be realized by reference to the drawings. In the enclosed figures, elements and components may have reference labels.

FIG. 1 shows an exemplary flow of the system and methods for the present invention;

FIGS. 2A-2E show exemplary diagrams of the flow of the system and methods for the present invention;

FIG. 3 shows an exemplary of the flow for the of the member login node access;

FIG. 4 shows an exemplary of flow of the member login node record link to the member login node profile access to his or her organization;

FIG. 5 shows an exemplary of flow of the process of evaluating the usage of the member profile to list the services and products to be delivered and where they need to be delivered;

FIG. 6 shows an exemplary of the flow for the process for evaluation where the services can be obtained at a specific locale;

FIG. 7 shows an exemplary of block diagram of the method for selecting the closest location to the member login node;

FIG. 8 shows an exemplary of a simplified block diagram of the method for vendors displaying advertising and promotional campaign to the member(s);

FIG. 9 shows an exemplary of a simplified block diagram of the method for mapping the geo location longitude and latitude to a street address for delivery goods or to render services;

FIG. 10 shows an exemplary of a simplified block diagram of the method for vetting the merchants (vendors) and service providers into the network/marketplace for internet/cloud commerce.

### DETAILED DESCRIPTION OF THE INVENTION

While various aspects of certain embodiments have been summarized above, these and other aspects at the present invention shall now be described by the way of exemplary embodiments to which the present invention is not limited with reference to the accompanying drawing figures in which:

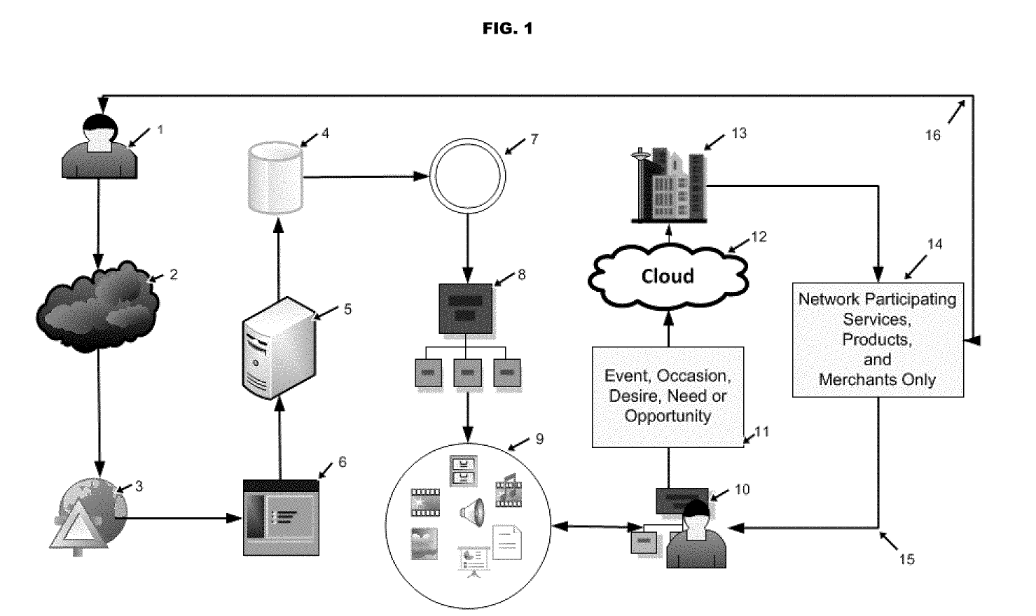

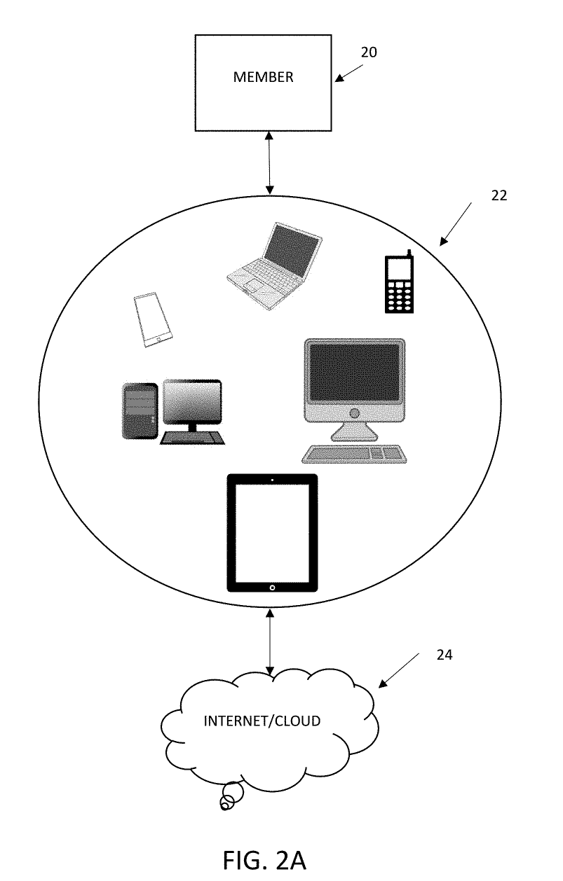

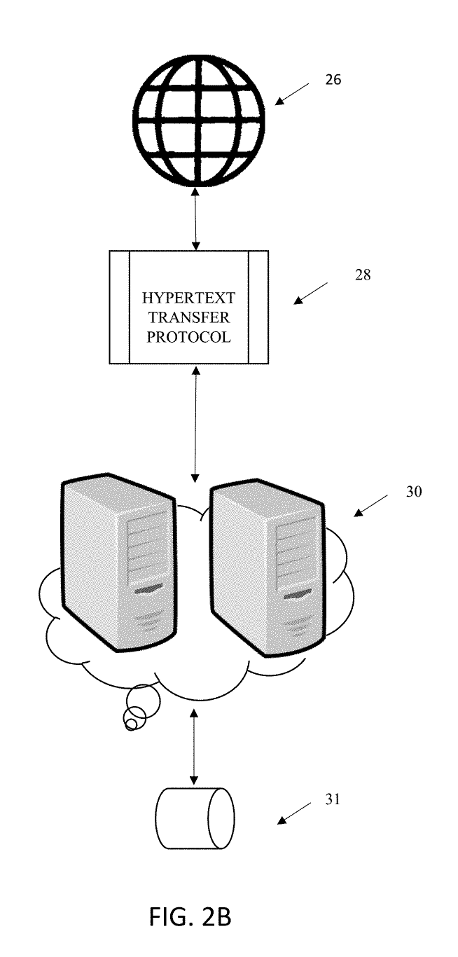

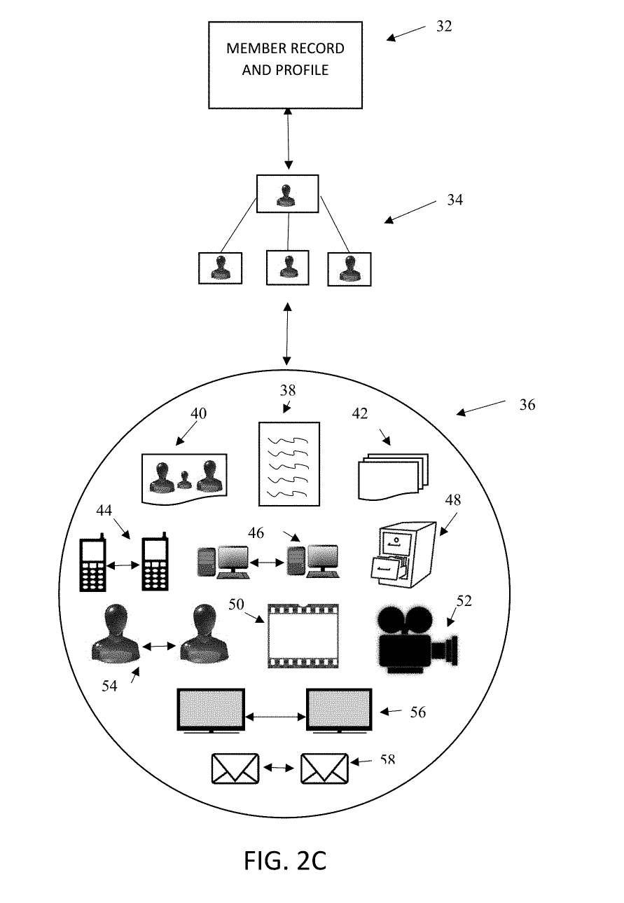

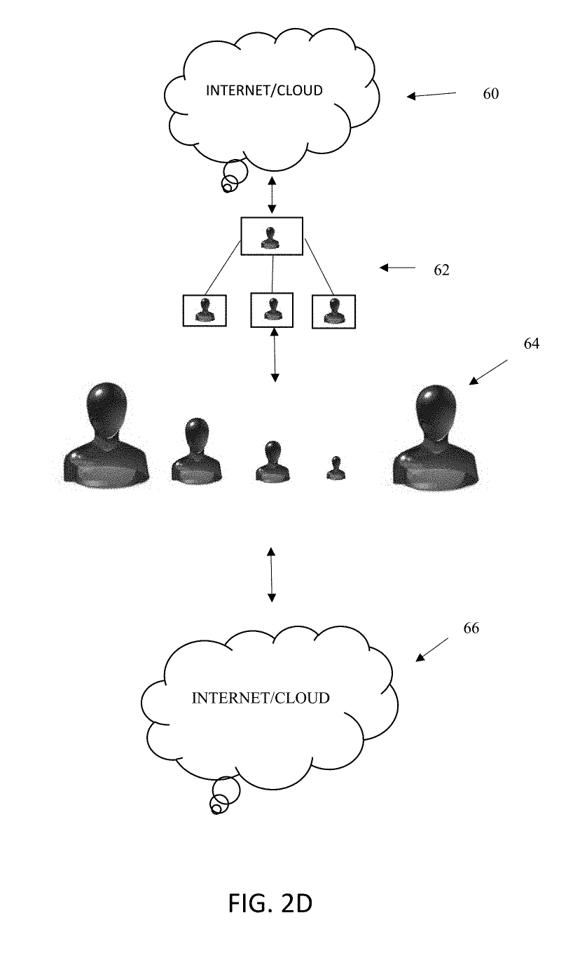

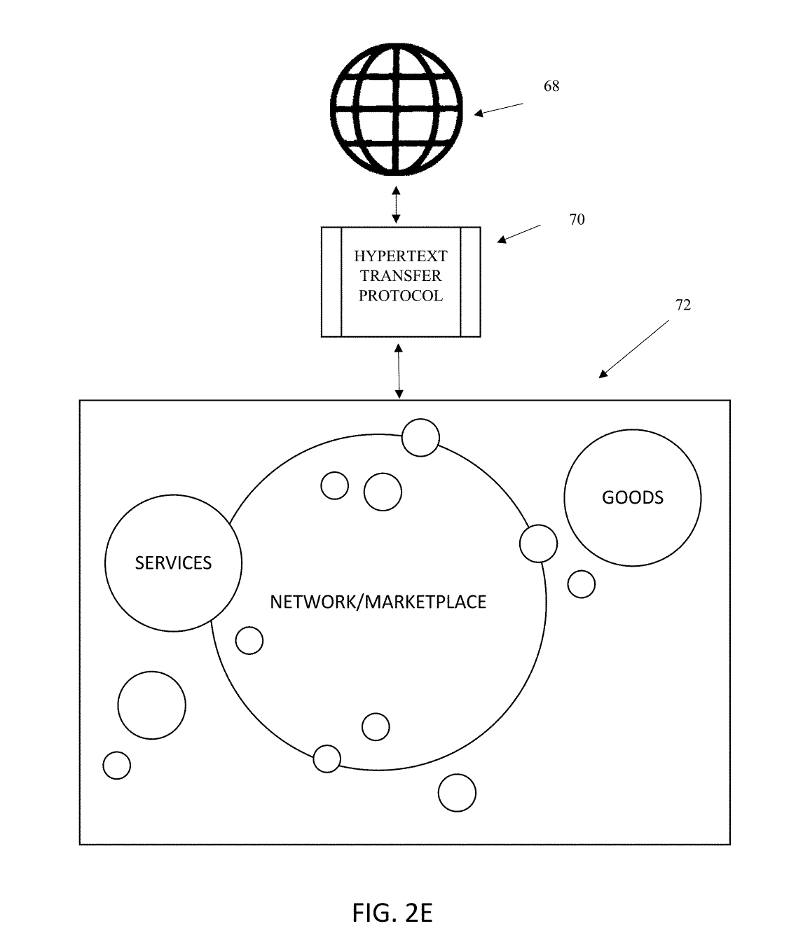

With reference now to the figures and in particular with references to FIGS. 1, 2A-2E, exemplary diagrams of the flow of the system and methods are provided in which illustrative embodiments may be implemented. It should be appreciated that FIGS. 1, 2A-2E are only exemplary and are not intended to assert or imply any limitation with regards to the environment in which different embodiments may be implemented. Many modifications to the depicted environments may be made.

With reference now to the figures, FIG. 1 depicts a pictorial representation of the flow of system and methods in which an illustrative embodiment may be implemented. The flow contains a login member node 1, which is the starting point of system, an individual that may belong to an organization such as a family, professional associations, clubs, educational associations, sporting associations religious associations, health, memberships, traveling association, civic associations, financial institutions and others, an is the medium that through the usage of a computer or other devices, which may include connections, such as wire, wireless communication links of fiber optics cables connect to the internet/cloud 2.

In the depicted example, the internet/cloud 2, connects to hypertext transfer protocol page 3, which on turns connects to applet 6, connected to a server in the internet/cloud 5, along with a database 4 and storage unit 7. In addition, the login member nodel, access his or her organization 8, through the pass of 2, 3, 6, 5, 4 and 7 and access the amenities of his or her organization membership, such as but not limited to file storage and archiving, music storing and playing, video clip storing and playing, voice messaging storing and recording, presentation storing and displaying.

In the depicted example, the member organization 8, through the connection of 3, 6, 5, 4, 7, and 9 provides the login member with access to the profiles of another members within the organization 10. In the depicted example, the server 5, stores the and provides the date, such as but not limited to member profiles, organization structures, hypertext transfer protocol pages, member IDs, member geo positions such as longitude and latitude, images, files archived, graphics and displays which can be accessed by computer and other devices that may connect to the internet/cloud, and may include additional servers, clients, and other devices not shown.

In the depicted example, other members of the organization 10, selected by the login member node 1, are considered as possible recipient(s) of goods and services for but not limited to an event, occasion, a desire, need or an opportunity 11. In the depicted example, the login member node obtains from the server in the internet/cloud 5, a geo location for the member or members of the organization 10, and with this information and the selection of the goods or services to be obtained from 11, connects to the internet/cloud 12, and search is conducted to obtain those goods and services from local services providers and merchants 13, which are participating in a vetted network or marketplace 14.

In the depicted example, good and services procured from 13 and 14 are sent to 10 through the connection and process in 15, and the information on shipping and payment is submitted back to 1 through 16, with a confirmation of shipping or pick-up.

With reference now to FIGS. 2A-2E, are exemplary diagrams of the flow of the system and methods are provided in which illustrative embodiments may be implemented. It should be appreciated that FIGS. 2A-2E are only exemplary and are not intended to assert or imply any limitation with regards to the environment in which different embodiments may be implemented. Many modifications to the depicted environments may be made.

With reference now to the figures, FIG. 2A depicts a pictorial representation of the flow of system and methods in which an illustrative embodiment may be implemented. The flow contains a login member node 20, which is the starting point of system, an individual that may belong to an organization such as a family, professional associations, clubs, educational associations, sporting associations religious associations, health, memberships, traveling association, civic associations, financial institutions and others, an is the medium that through the usage of a computer or other devices in circle 22, such as but not limited a personal computer, tablet, smartphones, Macintosh computers, iPad, iPhone and laptops computers, which may include connections, such as wire, wireless communication links of fiber optics cables connect to the internet/cloud 24.

With reference now to figured, FIG. 2B and proceeding from FIG. 2A, FIG. 2B depicts a pictorial representation of the flow of system and methods in which an illustrative embodiment may be implemented. The flow contains the continuation and starting point of the World Wide Web. In the depicted example, World Wide Web 26, a connection from the internet/cloud 24 on FIG. 2A, connects to hypertext transfer protocol page 28, which on turns connects to applet in a server in the internet/cloud 30, along with a database 31.

With reference now to figured, FIG. 2C and proceeding from FIG. 2B, FIG. 2C depicts a pictorial representation of the flow of system and methods in which an illustrative embodiment may be implemented. The flow contains the continuation and starting point of the login member node record and profile 32. In the depicted example, the login member node record and profile 32, access his or her organization 34, and access the amenities of his or her organization membership 36, such as but not limited to file storage 48, and archiving 42, music storing and playing 38, video clip storing and playing 50, voice messaging storing and recording 44, presentation storing and displaying 56, email and messaging 58, conferencing 56, video recording 52, file exchange 46, media and picture storing, displaying 40 and member chat 54.

With reference now to figured, FIG. 2D and proceeding from FIG. 2C, FIG. 2D depicts a pictorial representation of the flow of system and methods in which an illustrative embodiment may be implemented. The flow contains the continuation and starting point of the Internet/Cloud 60. In the depicted example, the Internet/Cloud 60, flows through the member login node organization 62, from the point a selection by the member login node 20 on FIG. 2A, select member(s) from his or her organization 64, as a recipient for goods and services to be acquired, the flows connect and continues to the internet/cloud 66.

With reference now to figured, FIG. 2E and proceeding from FIG. 2D, FIG. 2E depicts a pictorial representation of the flow of system and methods in which an illustrative embodiment may be implemented. The flow contains the continuation and starting point of the World Wide Web 68. In the depicted example, the World Wide Web 68, flows through the hypertext transfer protocol page 70, from this with the information of the recipient location and good and services to be acquired a search in performed in the network/marketplace 72 for such goods or services.

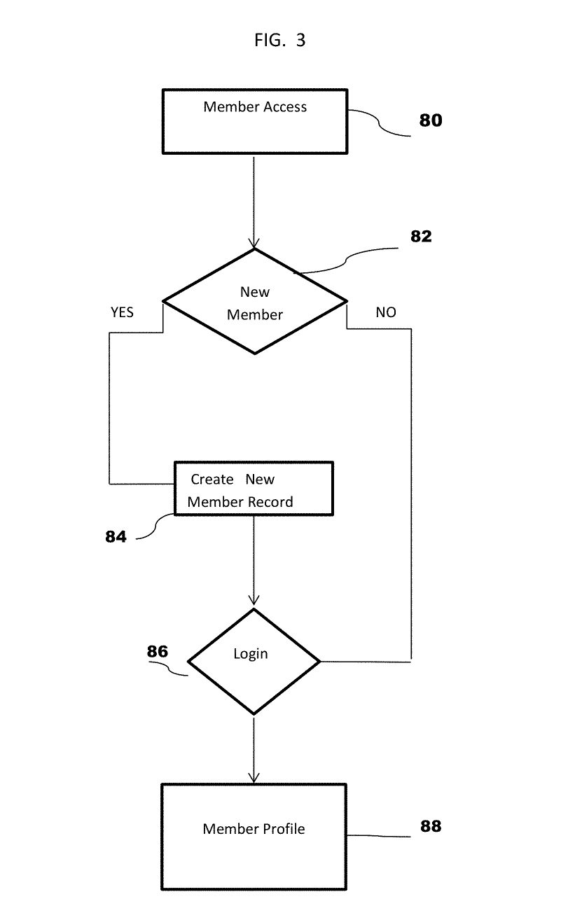

With reference now to FIG. 3, is an exemplary diagram for the flow of the member login node access, in which an illustrative embodiment may be implemented. It should be appreciated that FIG. 3 is only exemplary and is not intended to assert or imply any limitation with regards to the environment in which different embodiments may be implemented. Many modifications to the depicted environments may be made.

With reference now to the figures, FIG. 3 depicts a pictorial representation of an exemplary embodiment of the flow to create a member record access. The member login node is able to create access by logging into the system through the hypertext transfer protocol page on an internet web portal 80, if she or he is a new member 82, the member is required to create a new member login node record 84, if the member is an existing member, he or she is required to login 86, once the member creates the record 84, member is able to login 86, once the member is log into the system, member should be able to access members profile 88.

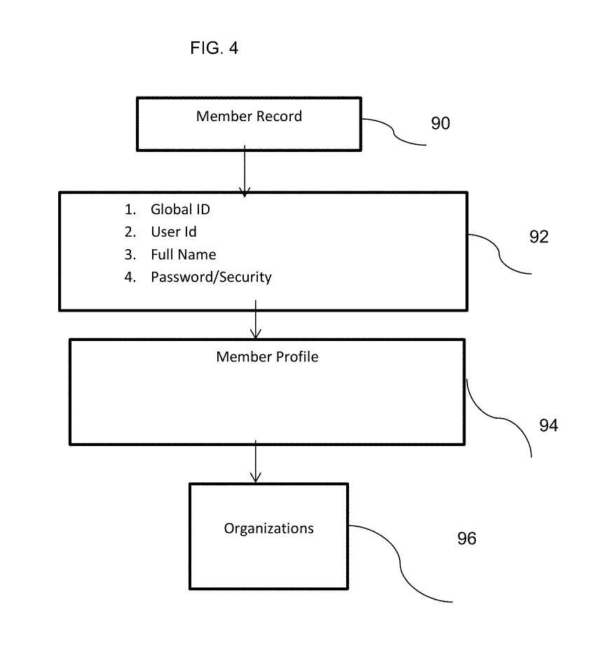

With reference now to FIG. 4, is an exemplary diagram for the flow of the member login node record link to the member login node profile access to his or her organization, in which an illustrative embodiment may be implemented. It should be appreciated that FIG. 4 is only exemplary and is not intended to assert or imply any limitation with regards to the environment in which different embodiments may be implemented. Many modifications to the depicted environments may be made.

With reference now to the figures, FIG. 4 depicts a pictorial representation of an exemplary embodiment for the flow of the member login node record link to the member login node profile access profile access to his or her organization. The member login node record 90, may be composed of global ID user ID, full name, password and security features 92, the member profile in this invention is curtailed to each individual organization preferences, which may satisfy the members preferences to the organizations the member is associated with 94, members could belong to many organizations such as but not limited to health organizations, religious organizations, families, professional organizations, travel organizations, civic organizations and others 96.

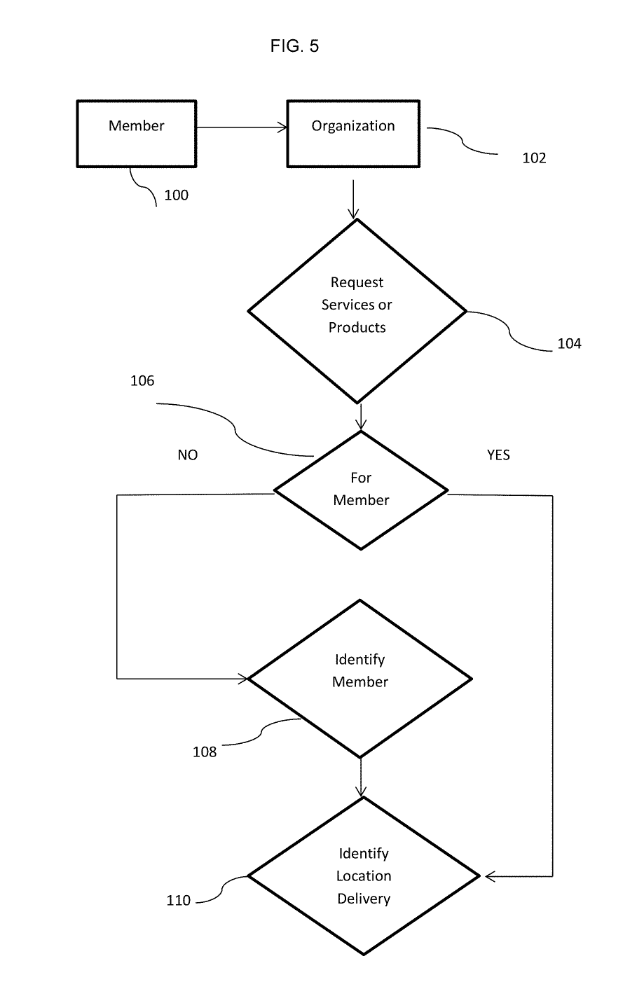

With reference now to FIG. 5, is an exemplary diagram for the flow of the process of evaluating the usage of the member profile to list the services and products to be delivered and where they need to be delivered, in which an illustrative embodiment may be implemented. It should be appreciated that FIG. 5 is only exemplary and is not intended to assert or imply any limitation with regards to the environment in which different embodiments may be implemented. Many modifications to the depicted environments may be made.

With reference now to the figures, FIG. 5 depicts a pictorial representation of an exemplary embodiment for the process of evaluating the usage of the member profile to list the services and products to be delivered and where they need to be delivered, the member login node requesting the services or goods 100, flows to the organization to which the member belongs, such as but not limited to a family, a religious organization, a professional organization, a civic association and others 102, flows to the request for services and products to be rendered or delivered to the selected member(s) 104, if the services or products are for the member requesting the services 106, the processing will identify the location for the member to whom the services to be rendered 108, based on geo location for the requesting member. If these services or goods are for another member, process will identify the member's location based on the geo location, and identify the location where the services and goods are to be rendered or delivered, based on geo location 110.

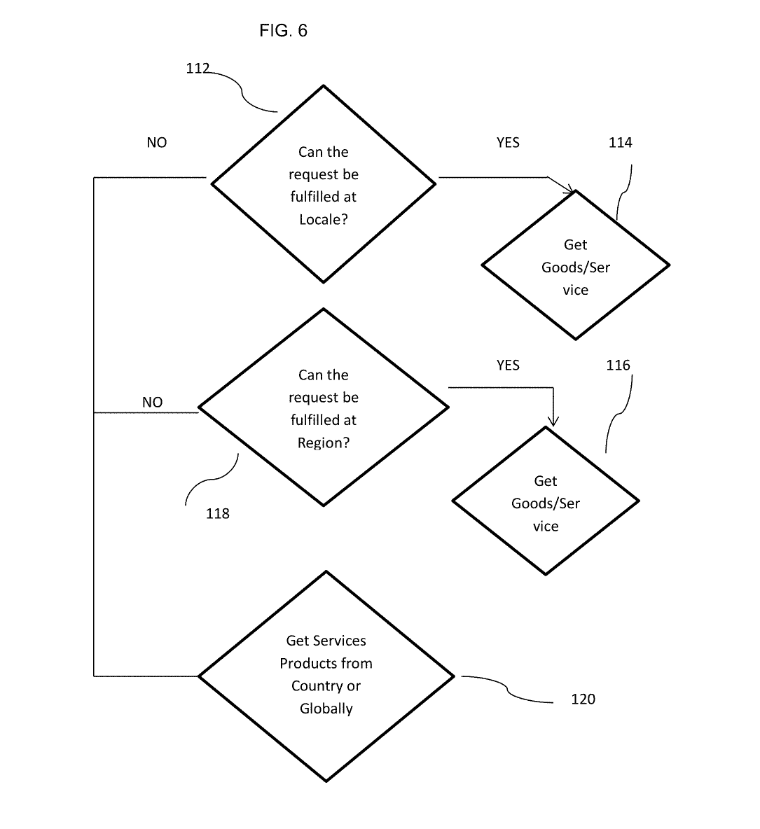

With reference now to FIG. 6, is an exemplary diagram for the flow of the process for evaluation where the services can be obtained at a specific locale, in which an illustrative embodiment may be implemented. It should be appreciated that FIG. 6 is only exemplary and is not intended to assert or imply any limitation with regards to the environment in which different embodiments may be implemented. Many modifications to the depicted environments may be made.

With reference now to the figures, FIG. 6 depicts a pictorial representation of an exemplary embodiment of the process for evaluation where the services can be obtained at a specific locale. This flow of the process, finds service providers and merchants for the specific location defined by the geo location. Once the location is determined, it advises if the goods and services are available and if they can be delivered or rendered at that locale identified by the geo position 112. If the services and goods are available at that location, the service providers or merchants will contract with the member login node, the process will recommend to deliver the goods or render the service(s) 114. If goods or services are not available at the locale, the process will search for those services and goods at the regional locale or the closet locale 118, further from 112. If the goods or services are available at the region locale, the process will recommend getting the services or goods from the region locale 116. If goods and services are not available at the region locale 118, the process will recommend to procure the goods and services to be provided or rendered at the country and/or globally 120.

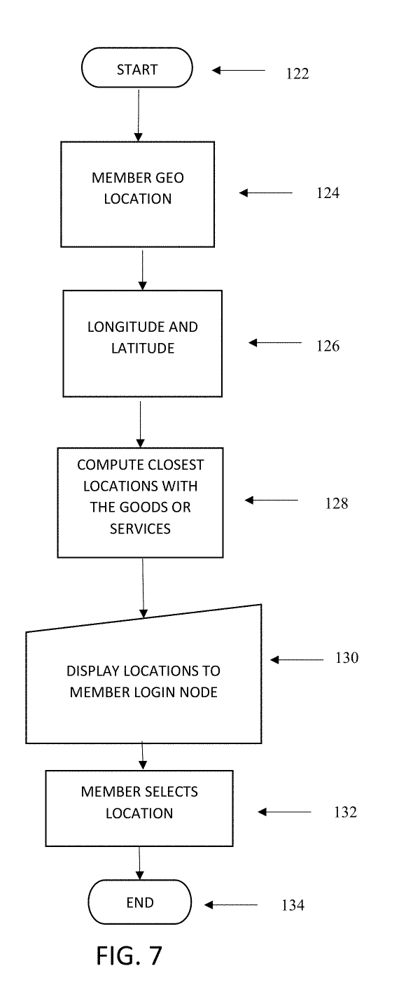

With reference now to FIG. 7, is an exemplary block diagram of the method for selecting the closest location to the member login node, in which an illustrative embodiment may be implemented. It should be appreciated that FIG. 7 is only exemplary and is not intended to assert or imply any limitation with regards to the environment in which different embodiments may be implemented. Many modifications to the depicted environments may be made.

With reference now to the figures, FIG. 7 depicts a pictorial representation of an exemplary embodiment of the method for selecting the closest location to the member login node. This block diagram show the process for the method that may be used for selecting the closest location and displays such location to the member login node, beginning 122 with obtaining the recipient member geo location node 124, then inspects the longitude and latitude for the member(s) selected to receive the goods and services 126, the process then searches by using geo locations for the closest locations to the recipient that have the go goods required or is able to perform the services requested 128, the process then display the locations to the member login node 130, who selects the location to where the goods and services are going to be either delivered or rendered 132, ending the process and method for selecting the closest location to the recipient 134.

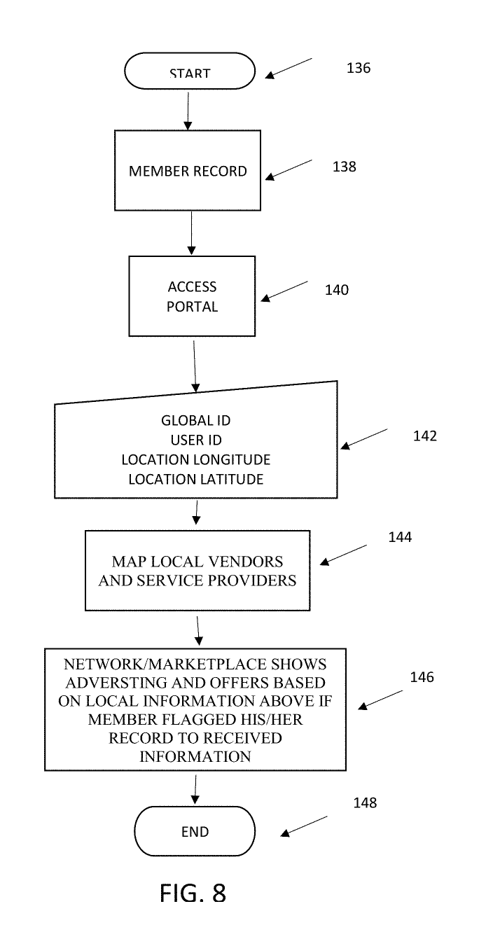

With reference now to FIG. 8, is an exemplary of a simplified block diagram of the method for vendors displaying advertising and promotional campaign to the member(s), in which an illustrative embodiment may be implemented. It should be appreciated that FIG. 8 is only exemplary and is not intended to assert or imply any limitation with regards to the environment in which different embodiments may be implemented. Many modifications to the depicted environments may be made.

With reference now to the figures, FIG. 8 depicts a pictorial representation of an exemplary embodiment of the method for vendors displaying advertising and promotional campaign to the member. This block diagram show the process for the method that may be used for vendors displaying advertising and promotional campaign to the member(s), beginning 136 with the member record 138, who access the system through a hypertext transfer protocol page portal by using a computer or other devices that connect to the internet/cloud 140, then the member's global ID, user ID, location longitude and location latitude are collected for processing 142, with this information the method maps and searches for merchants(vendors) and service providers, closest to the member that may have advertising or promotional campaigns 144, the process displays the merchants or service providers advertising campaigns and offers if the member flagged his or her record to receive the information 146, ending the method for vendors displaying advertising and promotional campaign to the member 148.

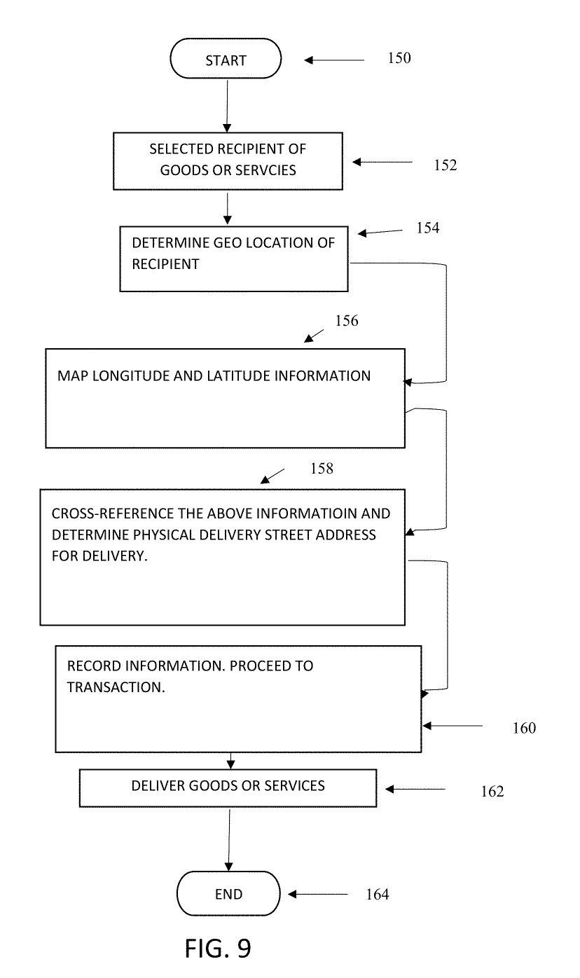

With reference now to FIG. 9, is an exemplary of a simplified block diagram of the method for mapping the geo location longitude and latitude to a street address for delivery goods or to render services, in which an illustrative embodiment may be implemented. It should be appreciated that FIG. 9 is only exemplary and is not intended to assert or imply any limitation with regards to the environment in which different embodiments may be implemented. Many modifications to the depicted environments may be made.

With reference now to the figures, FIG. 9 depicts a pictorial representation of an exemplary embodiment of the method for mapping the geo location longitude and latitude to a street address for delivery goods or to render services. This block diagram shows the process for the method that may be used for mapping the geo location longitude and latitude to a street address for delivery goods or to render services, beginning 150, displaying the member(s) selected by the member login node to receive the goods or services 152, then the process determines base on the recipient records, the geo location 154, the process obtains based on the gel locations, the longitude and latitude information 156, with this information the process cross-reference the longitudes and latitudes to street address(es) in which the goods and services are going to be delivered or rendered 158, then the process records the information and proceeds to the transaction 160, with this information the merchants or services providers deliver or render the goods or services 162, ending the method for mapping the geo location longitude and latitude to a street address for delivery goods or to render services.

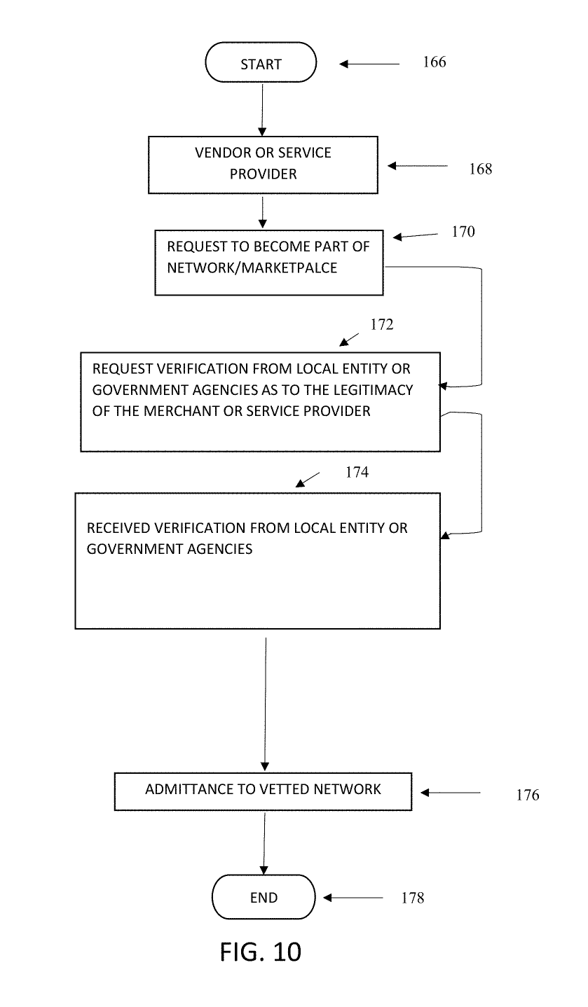

With reference now to FIG. 10, is an exemplary of a simplified block diagram of the method for vetting the merchants (vendors) and service providers into the network/marketplace for internet/cloud commerce, in which an illustrative embodiment may be implemented. It should be appreciated that FIG. 10 is only exemplary and is not intended to assert or imply any limitation with regards to the environment in which different embodiments may be implemented. Many modifications to the depicted environments may be made.

With reference now to the figures, FIG. 10 depicts a pictorial representation of an exemplary embodiment of the method for vetting the merchants (vendors) and service providers into the network/marketplace for internet/cloud commerce. This block diagram shows the process for the method that may be used for vetting the merchants (vendors) and service providers into the network/marketplace for internet/cloud commerce, beginning 166, potential merchants (vendors) or service providers 168, request to become part of the network/marketplace for internet/cloud commerce 170, such request may be reviewed or authenticated by registering or requesting a verification from a local entity or government agency in which the merchant or service providers operates. The entities may be but are not limited to Chamber of Commerce, Municipalities, County or regional governments and postal services 172, which provides verification to be submitted by the merchants or service providers 174, after which, the merchants or services providers are vetted and admitted into the network/marketplace for internet/cloud commerce 176, ending the method for vetting the merchants (vendors) and service providers into the network/marketplace for internet/cloud commerce.

I claim:

1. A method for local commerce through the Internet or cloud with the usage of geo locations comprising:
selecting the closest location to the recipient of goods and services;
directing goods and services to the closest location to the recipient of goods and services;
utilizing a network/marketplace with independently vetted merchants and service providers;
aiding local economies by providing a network/marketplace directed to prioritize local merchants and service providers;
providing local merchants and service providers with a network/market place access to local members for adverting and campaigns; and
matching the closest recipient with merchants and service providers using geo locations, reducing the distance from the shipping point to the delivery location.

2. The method of claim 1, wherein a reduction of delivery cost and time by matching closest merchant and service provider to the recipient using geo locations, reducing the distance from the shipping point to the delivery location.

3. A system for local internet/cloud commerce by the usage of geo locations, said system comprising:
one or more hypertext transfer protocol pages;
one or more computer connected to the internet or cloud;
one or more servers connected to the internet or cloud;
one or more databases stored in server in the internet or cloud;
one or more devices able to connected the internet or cloud;
one or more members of an organization or various organization able to connect to the internet or cloud;
more than one vetted merchants or service providers connected to the internet or cloud.
